(19) United States
(12) Patent Application Publication
(10) Pub. No.: US 2025/0159738 A1
(43) Pub. Date: May 15, 2025

(54) Method And System For Dynamic Wireless Connection Management

(71) Applicant: Platform Science, Inc., San Diego, CA (US)

(72) Inventors: Scott Kopchinsky, San Diego, CA (US); Don Son, San Diego, CA (US); John C. Kennedy, San Diego, CA (US); Jacob Fields, San Diego, CA (US); Hugo Garcia, El Cajon, CA (US); David Story, San Diego, CA (US); Patrick Lilavois, San Diego, CA (US); Jairo Barros, San Diego, CA (US)

(73) Assignee: Platform Science, Inc., San Diego, CA (US)

(21) Appl. No.: 19/022,972

(22) Filed: Jan. 15, 2025

Related U.S. Application Data
(63) Continuation of application No. 17/384,768, filed on Jul. 25, 2021.
Application No. 17/384,768 is a continuation-in-part of application No. 16/927,231, filed on Jul. 13, 2020, now Pat. No. 11,197,330.
Application No. 16/927,231 is a continuation-in-part of application No. 16/870,955, filed on May 9, 2020, now Pat. No. 11,330,644.
Application No. 16/870,955 is a continuation-in-part of application No. 16/416,396, filed on May 20, 2019, now Pat. No. 10,652,935.
Application No. 16/416,396 is a continuation-in-part of application No. 16/118,436, filed on Aug. 31, 2018, now Pat. No. 10,334,638.
Application No. 16/118,436 is a continuation of application No. 15/917,633, filed on Mar. 11, 2018, now Pat. No. 10,070,471.
Application No. 15/917,633 is a continuation of application No. 15/624,814, filed on Jun. 16, 2017, now Pat. No. 9,961,710.
Application No. 16/927,231 is a continuation-in-part of application No. 16/664,906, filed on Oct. 27, 2019, now Pat. No. 10,803,682.
Application No. 16/664,906 is a continuation of application No. 15/859,380, filed on Dec. 30, 2017, now Pat. No. 10,475,258.
Application No. 15/859,380 is a continuation-in-part of application No. 15/624,814, filed on Jun. 16, 2017, now Pat. No. 9,961,710.
(60) Provisional application No. 62/873,922, filed on Jul. 14, 2019.
(60) Provisional application No. 62/352,014, filed on Jun. 19, 2016.
(60) Provisional application No. 62/441,290, filed on Dec. 31, 2016.
(60) Provisional application No. 62/441,298, filed on Dec. 31, 2016.
(60) Provisional application No. 62/441,315, filed on Dec. 31, 2016.
(60) Provisional application No. 63/058,460, filed on Jul. 29, 2020.

(51) Int. Cl. H04W 76/10; H04L 67/12; H04W 4/40; H04W 76/19; H04W 84/00; H04W 84/12

(52) U.S. Cl. CPC H04W 76/10; H04L 67/12; H04W 4/40; H04W 76/19; H04W 84/005; H04W 84/12

(57) ABSTRACT

A system and method (500) for managing radio frequency (RF) connections for a plurality of devices (1055) associated with a plurality of vehicles. The method (500) includes monitoring, at management communication device (1050), WiFi broadcast signals from wireless communication devices (1055). The method (500) also includes managing the strength and reception sensitivity of each of the WiFi broadcast signals on each of the wireless communication devices (1055). Each of the wireless communication devices (1055) is assigned to a set of wireless communication devices. The method (500) also includes prioritizing, at management communication device (1050), each of the wireless communication device (1055).

### CROSS REFERENCES TO RELATED APPLICATIONS

The Present Application is a continuation application of U.S. patent application Ser. No. 17/384,768, filed on Jul. 25, 2021, which claims priority to U.S. Provisional Patent Application No. 63/058,460, filed on Jul. 29, 2020, now expired, and U.S. patent application Ser. No. 17/384,768 is also a continuation-in-part application of U.S. patent application Ser. No. 16/927,231, filed on Jul. 13, 2020, now U.S. Pat. No. 11,197,330, issued on Dec. 7, 2021, which claims priority to U.S. Provisional Patent Application No. 62/873,922, filed on Jul. 14, 2019, now expired, and U.S. patent application Ser. No. 16/927,231 is a continuation-in-part application of U.S. patent application Ser. No. 16/870,955, filed on May 9, 2020, now U.S. Pat. No. 11,330,644, issued on May 10, 2022, which is a continuation-in-part application of U.S. patent application Ser. No. 16/416,396, filed on May 20, 2019, now U.S. Pat. No. 10,652,935, issued on May 12, 2020, which is a continuation-in-part application of U.S. patent application Ser. No. 16/118,436, filed on Aug. 31, 2018, now U.S. Pat. No. 10,334,638, issued on Jun. 25, 2019, which is a continuation application of U.S. patent application Ser. No. 15/917,633, filed on Mar. 11, 2018, now U.S. Pat. No. 10,070,471, issued on Sep. 4, 2018, which is a continuation application of U.S. patent application Ser. No. 15/624,814, filed on Jun. 16, 2017, now U.S. Pat. No. 9,961,710, issued on May 1, 2018, which claims priority to U.S. Provisional Patent Application No. 62/352,014, filed on Jun. 19, 2016, now expired, and U.S. patent application Ser. No. 16/927,231 is a continuation-in-part application of U.S. patent application Ser. No. 16/664,906, filed on Oct. 27, 2019, now U.S. Pat. No. 10,803,682, issued on Oct. 13, 2020, which is a continuation application of U.S. patent application Ser. No. 15/859,380, filed on Dec. 30, 2017, now U.S. Pat. No. 10,475,258, issued on Nov. 12, 2019, which is a continuation-in-part application of U.S. patent application Ser. No. 15/624,814, filed Jun. 16, 2017, now U.S. Pat. No. 9,961,710, issued on May 1, 2018, which claims priority to U.S. Provisional Patent Application No. 62/352,014, filed on Jun. 19, 2016, now expired, and U.S. patent application Ser. No. 15/859,380 claims priority to U.S. Provisional Patent Application No. 62/441,290, filed on Dec. 31, 2016, now expired, U.S. Provisional Patent Application No. 62/441,298, filed on Dec. 31, 2016, now expired, and U.S. Provisional Patent Application No. 62/441,315, filed on Dec. 31, 2016, now expired, each of which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention generally relates to managing congestion on wireless networks for vehicles.

### Description of the Related Art

The prior art discusses various techniques for wireless networks for vehicles.

U.S. Pat. No. 9,215,590 for Authentication Using Vehicle Data Pairing discloses the wireless pairing of a portable device with an on-board computer of a vehicle for authenticating a transaction with a third party.

General definitions for terms utilized in the pertinent art are set forth below.

Beacon is a management frame that contains all of the information about a network. In a WLAN, Beacon frames are periodically transmitted to announce the presence of the network.

BLUETOOTH technology is a standard short range radio link that operates in the unlicensed 2.4 gigaHertz band.

Code Division Multiple Access (“CDMA”) is a spread spectrum communication system used in second generation and third generation cellular networks, and is described in U.S. Pat. No. 4,901,307.

FTP or File Transfer Protocol is a protocol for moving files over the Internet from one computer to another.

GSM, Global System for Mobile Communications is a second generation digital cellular network.

Hypertext Transfer Protocol (“HTTP”) is a set of conventions for controlling the transfer of information via the Internet from a web server computer to a client computer, and also from a client computer to a web server, and Hypertext Transfer Protocol Secure (“HTTPS”) is a communications protocol for secure communication via a network from a web server computer to a client computer, and also from a client computer to a web server by at a minimum verifying the authenticity of a web site.

Internet is the worldwide, decentralized totality of server computers and data-transmission paths which can supply information to a connected and browser-equipped client computer, and can receive and forward information entered from the client computer.

Media Access Control (MAC) Address is a unique identifier assigned to the network interface by the manufacturer.

Memory generally includes any type of integrated circuit or storage device configured for storing digital data including without limitation ROM, PROM, EEPROM, DRAM, SDRAM, SRAM, flash memory, and the like.

Organizationally Unique Identifier (OUI) is a 24-bit number that uniquely identifies a vendor, manufacturer, or organization on a worldwide basis. The OUI is used to help distinguish both physical devices and software, such as a network protocol, that belong to one entity from those that belong to another.

Probe Request: A frame that contains the advertisement IE for a device that is seeking to establish a connection with a proximate device.

Probe Response: A frame that contains the advertisement IE for a device. The Probe Response is sent in response to a Probe Request.

Processor generally includes all types of processors including without limitation microprocessors, general purpose processors, gate arrays, array processors, application specific integrated circuits (ASICs) and digital signal processors.

SCP (Secure Connection Packet) is used to provide authentication between multiple devices or a local party and remote host to allow for secure communication or the transfer of computer files.

SSID (Service Set Identifier) is a 1 to 32 byte string that uniquely names a wireless local area network.

Transfer Control Protocol/Internet Protocol (“TCP/IP”) is a protocol for moving files over the Internet.

URL or Uniform Resource Locator is an address on the World Wide Web.

User Interface or UI is the junction between a user and a computer program. An interface is a set of commands or menus through which a user communicates with a program. A command driven interface is one in which the user enter commands. A menu-driven interface is one in which the user selects command choices from various menus displayed on the screen.

Web-Browser is a complex software program, resident in a client computer, that is capable of loading and displaying text and images and exhibiting behaviors as encoded in HTML (HyperText Markup Language) from the Internet, and also from the client computer's memory. Major browsers include MICROSOFT INTERNET EXPLORER, NETSCAPE, APPLE SAFARI, MOZILLA FIREFOX, and OPERA.

Web-Server is a computer able to simultaneously manage many Internet information-exchange processes at the same time. Normally, server computers are more powerful than client computers, and are administratively and/or geographically centralized. An interactive-form information-collection process generally is controlled from a server computer, to which the sponsor of the process has access.

Wireless Application Protocol (“WAP”) is an open, global specification that empowers users with mobile wireless communication devices (such as mobile phones) to easily access data and to interact with Websites over the Internet through such mobile wireless communication device. WAP works with most wireless communication networks such as CDPD, CDMA, GSM, PDC, PHS, TDMA, FLEX, reflex, iDEN, TETRA, DECT, DataTAC, Mobitex and GRPS. WAP can be built on most operating systems including PalmOS, WINDOWS, CE, FLEXOS, OS/9, JavaOS and others.

WAP Push is defined as an encoded WAP content message delivered (pushed) to a mobile communication device which includes a link to a WAP address.

Wireless AP (access point) is a node on the wireless local area network (WLAN) that allows wireless devices to connect to a wired network using Wi-Fi, or related standards.

In the past, the legacy provider was wired so there wasn't a congestion problem. With wireless, everything starts bundling up and congestion becomes an issue.

For 2.4 GHz there are 3 primary channels with channels in between. Although additional bands will be available in the future (5 GHz has a lot more available channels), simply adding more channels does not resolve the problem of congestion.

Congestion is a matter of physical space that is occupied—at some point there is no room, and things don't move smoothly or don't move at all.

In a big vehicle yard there may be 350 trucks, not all of them always in use, thus there are 350 clients and 350 access points. There is a need for a system that prioritizes certain access points over others, and turns down or turns off other access points—for example, when they're not being used.

### BRIEF SUMMARY OF THE INVENTION

For one or more authorized wireless devices that seek to pair to a “hub” device, the present invention is a system that comprises the ability to dynamically control for either the hub or devices seeking to pair to that hub's network. The system controls the broadcast strength of a signal emanating from a specific wireless device. The system also controls the signal reception sensitivity of a specific wireless device, and, the ability to trigger changes in broadcast or reception sensitivity based on user configurable condition sets, which comprise conditions such as a) vehicle state, b) vehicle location, c) operator duty status, d) operator work status, and e) device location.

One aspect of the present invention is a system for managing radio frequency (RF) connections for a plurality of devices under the control of an assigning authority. The system comprises a management communication device and wireless communication devices. The management communication device manages broadcast signal strength and reception sensitivity on each of the wireless communication devices. Each of the wireless communication devices is assigned to a set of wireless communication devices. The set includes devices that require pairing only between devices in the set. The management communication device prioritizes each of the wireless communication devices.

Another aspect of the present invention is a method for managing radio frequency (RF) connections for a plurality of devices associated with a plurality of vehicles. The method includes monitoring, at management communication device, WiFi broadcast signals from wireless communication devices. The method also includes managing the strength and reception sensitivity of each of the WiFi broadcast signals on each of the wireless communication devices. Each of the wireless communication devices is assigned to a set of wireless communication devices. The method also includes prioritizing, at management communication device, each of the wireless communication devices.

Yet another aspect of the present invention is a system for managing radio frequency (RF) connections for devices associated with vehicles. The system comprises a management communication device for a vehicle yard, and vehicle wireless communication devices. Each of the vehicle communication devices associated with a vehicle located within the vehicle yard. The management communication device manages broadcast signal strength and reception sensitivity on each of the vehicle wireless communication devices. Each of the vehicle wireless communication devices is assigned to a set of wireless communication devices of a plurality of sets. The set includes devices that require pairing only between devices in the set for a user configurable period of time, wherein the management communication device prioritizes each of the plurality of sets over one another.

Yet another aspect of the present invention is a method for managing radio frequency (RF) connections for devices associated with vehicles. The method includes monitoring, at management communication device for a vehicle yard, WiFi broadcast signals from a vehicle wireless communication devices. Each of the vehicle communication devices associated with a vehicle located within the vehicle yard. The method also includes managing the strength and reception sensitivity of each of the WiFi broadcast signals on each of the vehicle wireless communication devices. Each of the vehicle wireless communication devices is assigned to a set of wireless communication devices of a plurality of sets. The set includes devices that require pairing only between devices in the set for a user configurable period of time. The method also includes prioritizing, at management communication device for a vehicle yard, each of the plurality of sets over one another.

Yet another aspect of the present invention is a system for managing radio frequency (RF) connections for devices associated with vehicles. The system comprises a management communication device for a vehicle yard, and vehicle wireless communication devices. Each of the vehicle communication devices is associated with a vehicle located within the vehicle yard. The management communication device manages broadcast signal strength and reception sensitivity on each of the vehicle wireless communication devices. Each of the vehicle wireless communication devices is assigned to a set of wireless communication devices, and the set includes devices that require pairing only between devices in the set for a user configurable period of time. The management communication device prioritizes each of the vehicle wireless communication devices.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a block diagram of system for a secure communication protocol for connecting a wireless device to a single access point in a vehicle.

FIG. 1A is a continuation of the block diagram of FIG. 1.

FIG. 2 is a flow chart of a method for a secure connection to a wireless network of a vehicle.

FIG. 3 is an illustration of an operator identifying a vehicle through connection of a tablet computer to an unpublished network.

FIG. 4 is an isolated view of general electrical components of a mobile communication device.

FIG. 5 is an isolated view of general electrical components of a server.

FIG. 6 is a flow chart of a method for securely connecting a wireless device to a single access point in a vehicle.

FIG. 7 is an illustration of a system for securely connecting a wireless device to a single access point in a vehicle.

FIG. 8 is an illustration of an operator identifying a vehicle through connection of a tablet computer to an unpublished network.

FIG. 9 is an illustration of multiple sensors on a truck.

FIG. 9A is an illustration of multiple sensors on a truck connected to a BUS for the truck.

FIG. 10 is an illustration of dynamic connection management.

FIG. 10A is an illustration of dynamic connection management showing the local RF network.

FIG. 11 is a flow chart of a method for managing RF connections for a plurality of devices associated with a plurality of vehicles.

### DETAILED DESCRIPTION OF THE INVENTION

The system preferably manages a broadcast signal strength and reception sensitivity on each wireless communication device assigned to a “set” of wireless communication devices, where that set includes devices that require pairing only between devices in a specific set for a user configurable period of time.

Signal strength and reception sensitivity are dynamically scaled up or down between devices in the set to optimize the ability of the devices in the set to a) pair successfully, b) remain paired successfully, and c) re-pair successfully if pairing is interrupted.

User configurable rule sets are preferably implemented using server-side tools and delivered to devices in the Set by an assigning authority. The “Set” is defined as the hub and connected devices in a temporal location, such as a vehicle yard. Users can dynamically change the respective broadcast reception and sensitivities in the devices within each set manually, or, they can create rule sets that automatically include anticipated conditions that have pre-determined optimal settings. Anticipated conditions may rely on a) vehicle state or driving status, b) operator duty or work state, c) geographic location, and d) other hierarchal prioritization schemes employed by the authorized user or assigning authority.

The system controls relative to other sets at that same location. Also, the system controls other sets by reducing their priority for a channel. Users may dynamically change the respective broadcast reception and sensitivities within the Set device(s) or define priority or non-priority devices.

The system preferably randomizes channels. As additional bands become available in the future, they may be incorporated into channel randomization. The system uses channel randomization to help with congestion, but congestion is still a problem.

The system controls: transmit power (TX power, which can be done from either side (a management communication device or a plurality of wireless communication devices in a Set); beacon rate (slower so less bandwidth is utilized); and changing the data rate (if it is a controlled environment).

Control is done by the system using preferably geofencing and duty status/operator state. For geofencing, there are three preferred methods: a) Predetermined locations (going into the yard, turn the radio down so then all of the access point won't interfere); b) Dynamic self-awareness (access points can scan to see if there's too much traffic, and if so, turn down; this only works if the devices are in an area that is controlled); and c) Cloud, based on location.

The following is a preferred procedure for a Duty status/operator state: Is the tablet active? (Is the screen on or off? Is there motion? Is the operator logged on? Is the operator on duty? If not, then turn off WiFi). The devices also work together: a CVD would tell a tablet that the tablet is going into a congested area, and to be ready to configure for the congestion. If an operator wants to leave on the system that works together (devices and operator side) based on certain information that may include duty status and/or operator state.

One embodiment is a system/method for reducing and/or managing radio frequency (RF) connection (WiFi, etc.) congestion through controlling: transmission power (TX power, can be done from either side), beacon rate (make it slower so the device uses less bandwidth), data rate (in a controlled environment) of a secure wireless network of a vehicle, where the user can adjust these things based on at least one trigger, including: Location/geofence, Duty/work Status, Vehicle state (ignition on/ignition off), and State (on/off/standby) of device (anything that the assigning authority controls).

Where the trigger is based on certain information that may include a geofence comprising presence in a predetermined location, dynamic self-awareness, and the Cloud (based on location). Also, an assigning authority is a used to allow: Configurable controls, Prioritization scheme, and Channel control.

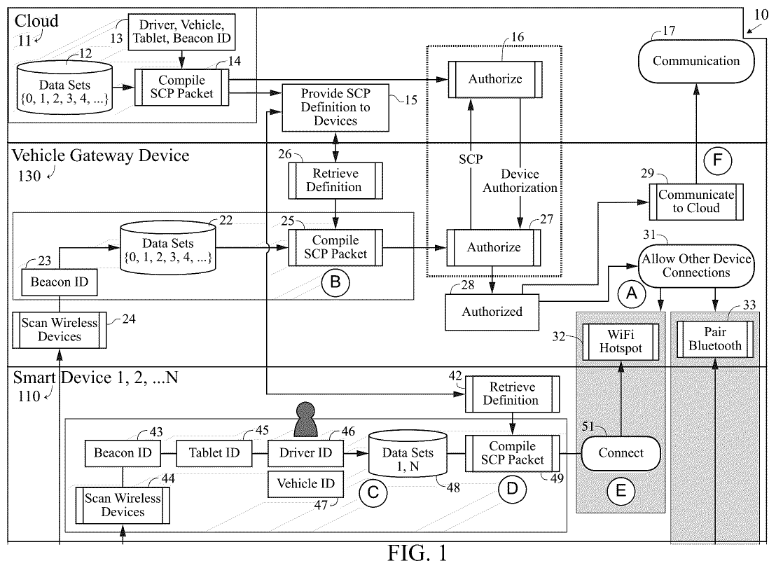

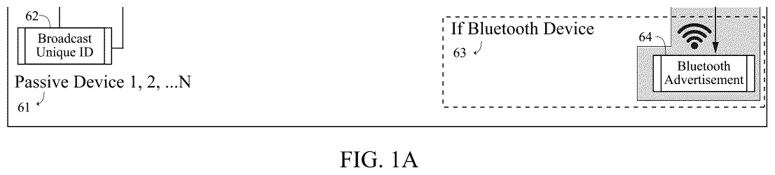

Secure pairing between devices can be accomplished as described below. A system 10 for securely connecting a wireless device to a single access point in a vehicle for a predetermined work assignment is set for the FIGS. 1 and 1A. The system 10 preferably comprises a remote server (cloud) 11, a vehicle gateway device 130, a smart device 110 and a passive device 61. The vehicle gateway device 130 is preferably a connected vehicle device (“CVD”).

The server/cloud 11 accesses dataset 12 and obtains operator information. Vehicle information, mobile device information (MAC address), passive device information (beacon ID) and other information to compile a SCP packet 14. At block 15, the server 11 provides SCP definitions to the vehicle gateway device 130 and the mobile device 110. At block 16 the server/cloud 11 authorizes the SCP. At block 17, the server/cloud 11 communicates with the vehicle gateway device 130.

The vehicle gateway device 130 uses datasets 22, with the beacon ID 23, a scan of wireless devices 24 along with the SCP definitions 26 received from the server/cloud 11 to compile a CVD compiled SCP packet 25. The CVD compiled SCP packet is sent to the cloud/server 11 at block 16 and authorization/validation of the CVD compiled SCP packet is received at block 27. At block 28 the SCP is authorized for broadcasting at the vehicle gateway device 130 a wireless network with a hidden and hashed SSID unique to the vehicle, the hidden and hashed SSID generated from the validated SCP packet. At block 29, the vehicle gateway device 130 communicates the broadcast with the server/cloud 11. At block 31, the vehicle gateway device 130 communicates with other devices, namely the smart device 110 over preferably a WiFi hotspot 32 and the passive device 61 by pairing using a BLUETOOTH communication protocol at block 33.

At block 49, the smart device (mobile device) 110 compiles a complied mobile device SCP packet from the SCP definitions 42, the data sets 48, the beacon ID 43, the Tablet ID 45, a operator ID 46, a vehicle ID 47 and scan of wireless devices 44. The mobile device 110 generates the hashed SSID and a passphrase from the complied mobile device SCP packet. At block 51, the mobile device 110 connects to the WiFi hotspot 32 of the vehicle device gateway 130.

The passive device 61 broadcast a unique ID at block 62, which is received by the mobile device 110 and the vehicle gateway device 130. At block 63, if a BLUETOOTH device, it broadcasts a BLUETOOTH advertisement at block 64.

An assigning authority in the server/cloud 11 defines the SCP. The server/cloud 11 sends the SCP definition and any other required data in datasets to the CVD 130 and the mobile device 110. The CVD 130 adds the contextual data from local datasets to the sever-sent data to compile its SCP based definition. The local datasets include data wirelessly scanned from passive devices, preferably transmitting a BLUETOOTH beacon. Other local datasets include information from the vehicle. The CVD 130 sends its compiled SCP packet to the server 11 for authorization. The server 11 verifies the CVD compiled SCP packet, and if valid, the server 11 transmits a validation/approval signal to the CVD 130. The CVD then generates an access point SSID/passphrase with SCP. Likewise, the mobile device 110 utilizes contextual data from local datasets to compile its SCP based on the definitions. The mobile device 110 connects to the access point of the CVD 130 using the SCP. The CVD 130 and the mobile device 110 also connect to the passive device 61 since it is part of the SCP definition.

An assigning authority is used to allow configurable controls, a prioritization scheme and/or a channel control between the management communication device and the wireless communication devices. A predetermined work assignment is a temporal event with a fixed start and completion based on assignable boundary conditions. The assignable boundary condition is at least one of a predetermined time period, a geographical destination, and a set route. Alternatively, the assignable boundary condition is any feature with a beginning and a termination. The assigning authority is performed by a person or persons, who have the appropriate authority and mechanisms to assign specific tasks and assets to a specific vehicle and vehicle operator or custodian, and to assign workflow assignments to it. The predetermined work assignment is assigned to a known person or entity that has its own primary networked device accessible through a password protected user interface, a specific name and password that auto-populates or otherwise automatically satisfies a plurality of credentials requirements, wherein the plurality of credential requirements are automatically available or revoked based on the assignable boundary condition identified in a pairing event.

In one embodiment, a CVD 130 broadcasts a WiFi wireless network with a hidden and hashed SSID unique to the host vehicle and protected by a unique, dynamically generated and hashed passphrase. The vehicle ID is entered into an application on the tablet that is then converted to the same hashed SSID and passphrase, which allows the tablet to attempt to connect to the corresponding CVD WiFi network and begin communication.

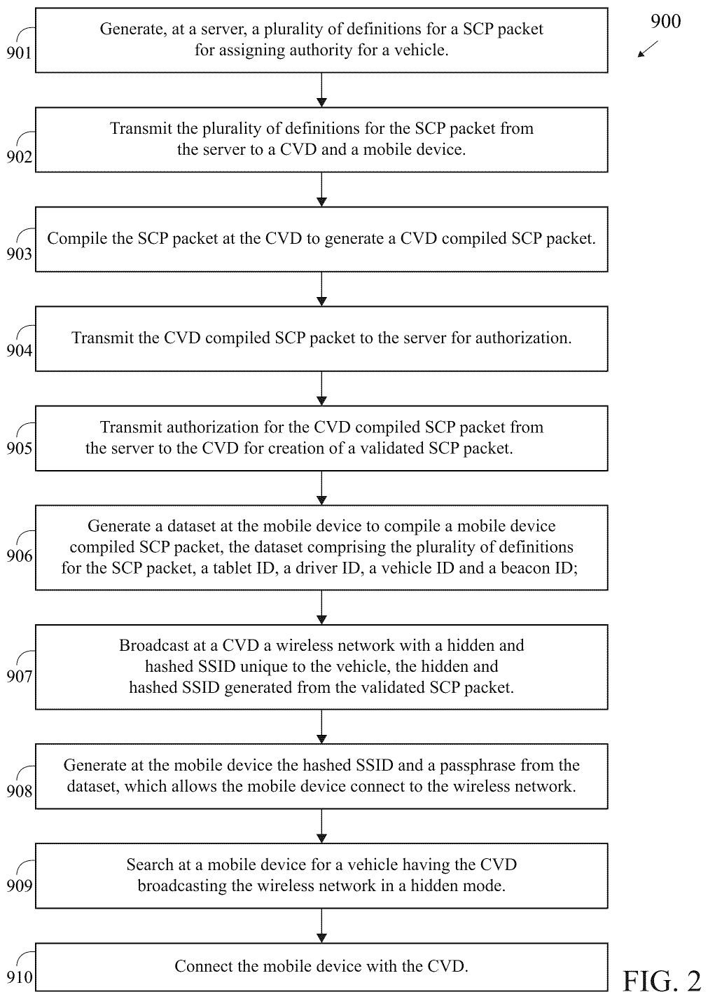

A method 900 for a secure connection to a wireless network of a vehicle is shown in FIG. 2. At block 901, a server generates definitions for a SCP packet for assigning authority for a vehicle. At block 902 the server transmits the definitions for the SCP packet to a CVD and a mobile device. At block 903, the CVD compiles the SCP packet to generate a CVD compiled SCP. At block 904, the CVD transmits the CVD compiled SCP to the server for authorization. At block 905, the server transmits authorization for the CVD compiled SCP from to the CVD for creation of a validated SCP. At block 906, the mobile device generates a dataset to compile a mobile device compiled SCP. At block 907, the CVD broadcasts at a wireless network with a hidden and hashed SSID unique to the vehicle. The hidden and hashed SSID is generated from the validated SCP packet. At block 908, the mobile device generates the hashed SSID and a passphrase from the dataset, which allows the mobile device connect to the wireless network. At block 909, the mobile device searches for a vehicle having the CVD broadcasting the wireless network in a hidden mode. At block 910, the mobile device securely connects with the CVD.

One embodiment is a system for vehicle to mobile device secure wireless communications. The system comprises a vehicle 210, a CVD 130, a mobile device 110 and a passive communication device 61. The vehicle 210 comprises an on-board computer with a memory having a vehicle identification number (VIN), a connector plug, and an motorized engine. The CVD 130 comprises a processor, a WiFi radio, a BLUETOOTH radio, a memory, and a connector for mating with the connector plug of the vehicle. The mobile device 110 comprises a graphical user interface, a mobile application, a processor, a WiFi radio, and a cellular network interface. The passive communication device 61 operates on a BLUETOOTH communication protocol. The server 11 is configured to generate a plurality of definitions for a SCP packet for assigning authority for the vehicle. The server 11 is configured to transmit the plurality of definitions for the SCP packet from the server to the CVD 130 and the mobile device 110. The CVD 130 is configured to compile the SCP packet to generate a CVD compiled SCP. The CVD 130 is configured to transmit the CVD compiled SCP to the server 11 for authorization. The server 11 is configured to transmit authorization for the CVD compiled SCP to the CVD 130 for creation of a validated SCP. The mobile device 110 is configured to generating a dataset to compile a mobile device compiled SCP. The CVD 130 is configured to broadcast a wireless network with a hidden and hashed SSID unique to the vehicle, the hidden and hashed SSID generated from the validated SCP packet. The mobile device 110 is configured to generate the hashed SSID and a passphrase from the dataset, which allows the mobile device connect to the wireless network. The mobile device 110 is configured to search for a vehicle having the CVD broadcasting the wireless network in a hidden mode. The mobile device 110 is configured to connect to the CVD 130 over the wireless network.

The dataset preferably comprises at least one of a plurality of definitions for the SCP packet, a tablet ID, a operator ID, a vehicle ID, a beacon ID, identified or defined entity/participant to the transaction, descriptions, actions, or states of thing, characteristics of identifiable devices, when present in a certain proximity and/or context.

Optionally, the mobile device 110 connects to a passive device, the passive device operating on a BLUETOOTH communication protocol. The passive device 61 is preferably a BLUETOOTH enabled device advertising a unique ID as a beacon or a complex system (speaker, computer, etc.) that emits BLUETOOTH enabled device advertising a unique ID as a beacon.

The mobile device 110 preferably receives input from a operator of the vehicle, and/or the server 11 contains the assigning authority that generates the SCP definitions.

The passive device 61 is preferably an internal device in the vehicle or an external device posted on a gate to a facility and generating a beacon. The beacon from the passive device is preferably a mechanism to ensure that the connection between the mobile device 110 and the CVD 130 occurs at a specific physical location dictated by the assigning authority through the server 11. Preferably, the automatic connection between the mobile device 110 and the CVD occurs because the assigning authority, through the server, has dictated that it occur.

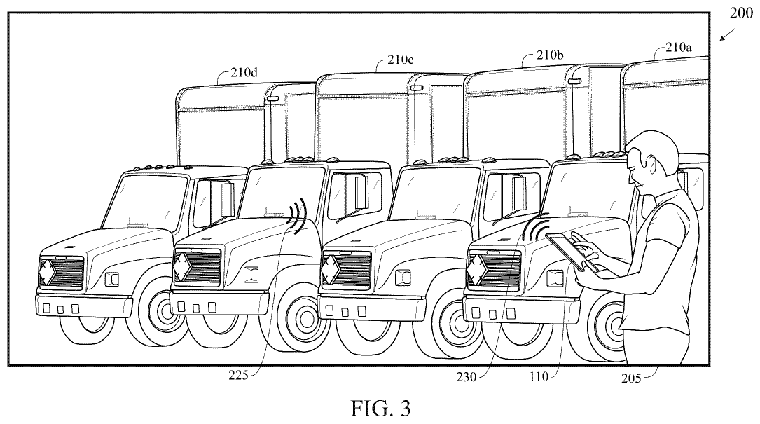

As shown in FIG. 3, each of a multitude of trucks 210a-210d broadcast a wireless signal for a truck specific network, with one truck 210c broadcasting a wireless signal 225. This can cause congestion in a vehicle yard. However, the SSID is not published so unless a operator is already in possession of the SSID, the operator will not be able to pair the tablet computer 110 with the CVD 130 of the truck 210 to which the operator is assigned. So even though the wireless signals are being “broadcast”, they will not appear on a operator's tablet computer 110 (or other mobile device) unless the tablet computer 110 has already been paired with the CVD 130 of the vehicle 210. A operator 205 in possession of a tablet computer 110 pairs, using a signal 230, the tablet computer 110 with the wireless network 225 of the CVD of the truck 210c, and thus the operator locates the specific truck 210c he is assigned to in a parking lot full of identical looking trucks 210a-d.

For example, on an IPHONE® device from Apple, Inc., the “UDID,” or Unique Device Identifier is a combination of forty numbers and letters, and is set by Apple and stays with the device forever.

For example, on an ANDROID based system, one that uses Google Inc.'s ANDROID operating system, the ID is set by Google and created when an end-user first boots up the device. The ID remains the same unless the user does a “factory reset” of the phone, which deletes the phone's data and settings.

The mobile communication device 110, or mobile device, is preferably selected from mobile phones, smartphones, tablet computers, PDAs and the like. Examples of smartphones and the device vendors include the IPHONE® smartphone from Apple, Inc., the DROID® smartphone from Motorola Mobility Inc., GALAXY S® smartphones from Samsung Electronics Co., Ltd., and many more. Examples of tablet computing devices include the IPAD® tablet computer from Apple Inc., and the XOOM™ tablet computer from Motorola Mobility Inc.

The mobile communication device 110 then a communication network utilized preferably originates from a mobile communication service provider (aka phone carrier) of the customer such as VERIZON, AT&T, SPRINT, T-MOBILE, and the like mobile communication service providers, provide the communication network for communication to the mobile communication device of the end user.

Wireless standards utilized include 802.11a, 802.11b, 802.11g, AX.25, 3G, CDPD, CDMA, GSM, GPRS, radio, microwave, laser, Bluetooth, 802.15, 802.16, and IrDA.

BLUETOOTH™ technology operates in the unlicensed 2.4 GHz band of the radio-frequency spectrum, and in a preferred embodiment the secondary device 30 and/or primary device 25 is capable of receiving and transmitting signals using BLUETOOTH™ technology. LTE Frequency Bands include 698-798 MHz (Band 12, 13, 14, 17); 791-960 MHz (Band 5, 6, 8, 18,19,20); 1710-2170 MHz (Band 1, 2, 3, 4, 9, 10, 23, 25, 33, 34, 35, 36, 37, 39); 1427-1660.5 MH (Band 11, 21, 24); 2300-2700 MHZ (Band 7, 38, 40, 41); 3400-3800 MHZ (Band 22, 42, 43), and in a preferred embodiment the secondary device 30 and/or the primary device 25 is capable of receiving and transmitting signals using one or more of the LTE frequency bands. WiFi preferably operates using 802.11a, 802.11b, 802.11 g, 802.11n communication formats as set for the by the IEEE, and in in a preferred embodiment the secondary device 30 and/or the primary device 25 is capable of receiving and transmitting signals using one or more of the 802.11 communication formats. Near-field communications (NFC) may also be utilized.

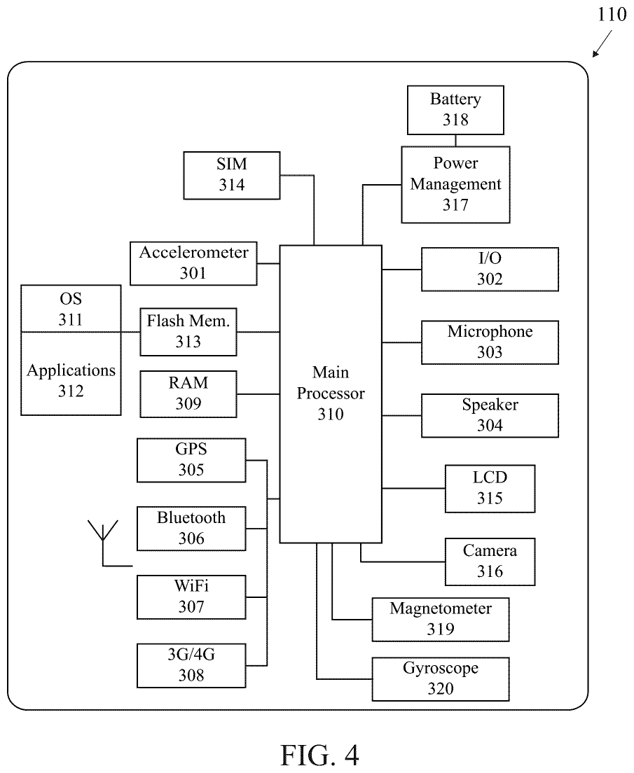

As shown in FIG. 4, a typical mobile communication device 110 preferably includes an accelerometer 301, I/O (input/output) 302, a microphone 303, a speaker 304, a GPS chipset 305, a Bluetooth component 306, a Wi-Fi component 307, a 3G/4G component 308, RAM memory 309, a main processor 310, an OS (operating system) 311, applications/software 312, a Flash memory 313, SIM card 314, LCD display 315, a camera 316, a power management circuit 317, a battery 318 or power source, a magnetometer 319, and a gyroscope 320.

Each of the interface descriptions preferably discloses use of at least one communication protocol to establish handshaking or bi-directional communications. These protocols preferably include but are not limited to XML, HTTP, TCP/IP, Serial, UDP, FTP, Web Services, WAP, SMTP, SMPP, DTS, Stored Procedures, Import/Export, Global Positioning Triangulation, IM, SMS, MMS, GPRS and Flash. Databases that may be used with the system preferably include but are not limited to MSSQL, Access, MySQL, Progress, Oracle, DB2, Open Source DBs and others. Operating system used with the system preferably include Microsoft 2010, XP, Vista, 2000 Server, 2003 Server, 2008 Server, Windows Mobile, Linux, Android, Unix, I series, AS 400 and Apple OS.

The underlying protocol at the cloud server 11, is preferably Internet Protocol Suite (Transfer Control Protocol/Internet Protocol (“TCP/IP”)), and the transmission protocol to receive a file is preferably a file transfer protocol (“FTP”), Hypertext Transfer Protocol (“HTTP”), Secure Hypertext Transfer Protocol (“HTTPS”) or other similar protocols. The transmission protocol ranges from SIP to MGCP to FTP and beyond. The protocol at the authentication server 40 is most preferably HTTPS.

Wireless standards include 802.11a, 802.11b, 802.11g, AX.25, 3G, CDPD, CDMA, GSM, GPRS, radio, microwave, laser, Bluetooth, 802.15, 802.16, and IrDA.

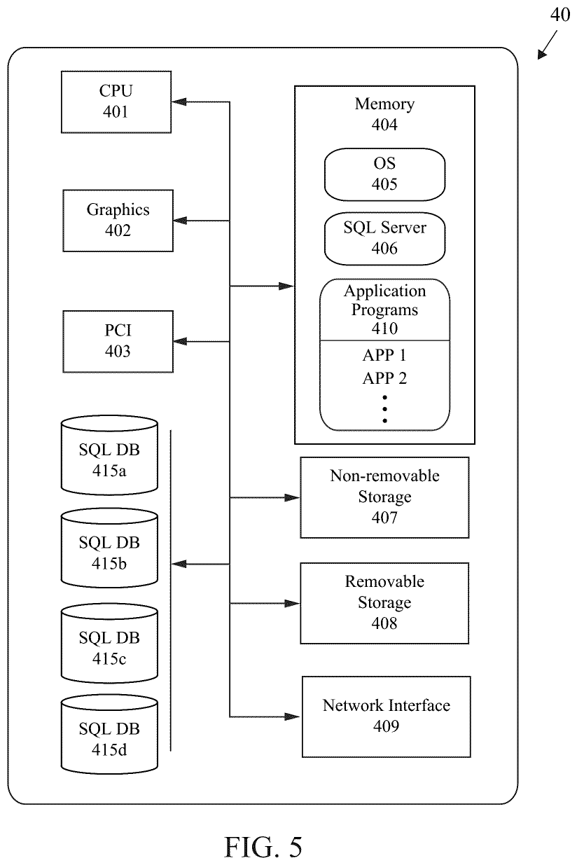

Components of a cloud computing server 40 of the system, as shown in FIG. 5, preferably includes a CPU component 401, a graphics component 402, PCI/PCI Express 403, memory 404, non-removable storage 407, removable storage 408, Network Interface 409, including one or more connections to a fixed network, and SQL database(s) 45a-45d, which includes the venue's CRM. Included in the memory 404, is an operating system 405, a SQL server 406 or other database engine, and computer programs/software 410. The server 40 also preferably includes at least one computer program configured to receive data uploads and store the data uploads in the SQL database. Alternatively, the SQL server can be installed in a separate server from the server 40.

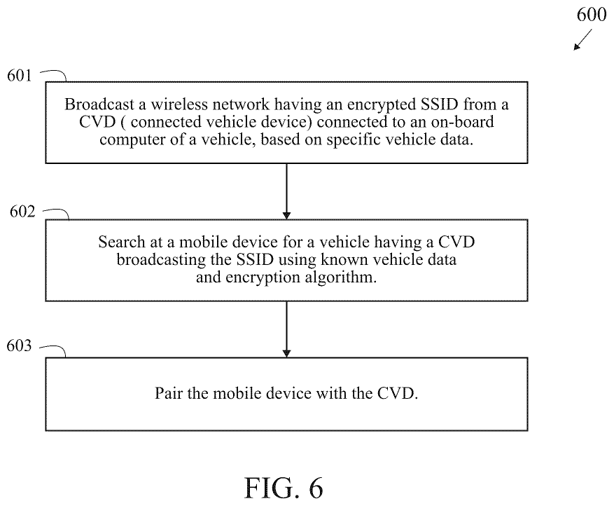

A flow chart for an alternative method 600 for a secure connection to a wireless network of a vehicle is shown in FIG. 6. At block 601, the CVD broadcasts an encrypted, blind SSID based on specific vehicle data. At block 602, leveraging the known vehicle data and the encryption algorithm a mobile device searches for a vehicle having a CVD broadcasting the wireless network. At block 603, the mobile device is connected with the CVD.

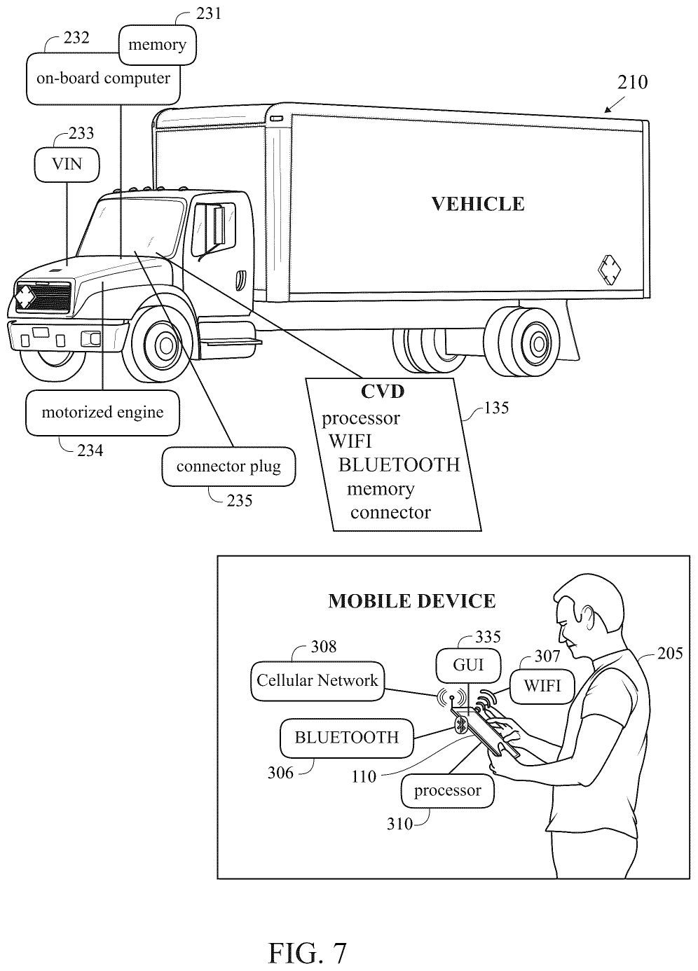

A system for a secure connection to a wireless network of a vehicle is shown in FIG. 7. A truck 210. Those skilled in the pertinent art will recognize that the truck 210 may be replaced by any type of vehicle (such as a bus, sedan, pick-up, sport utility vehicle, limousine, sports car, delivery truck, van, mini-van, motorcycle, and the like) without departing from the scope of spirit of the present invention. The truck 210 preferably comprises a motorized engine 234, a vehicle identification number (“VIN”), an on-board computer 232 with a memory 231 and a connector plug 235. The on-board computer 232 preferably has a digital copy of the VIN in the memory 231. The on-board computer 232 is preferably in communication with the motorized engine 234. The truck 210 may also have a GPS component for location and navigation purposes, a satellite radio such as SIRIUS satellite radio, a operator graphical interface display, a battery, a source of fuel and other components found in a conventional long distance truck.

Also in the truck 210 is a CVD 135 comprising a processor, a WiFi radio, a BLUETOOTH radio, a memory and a connector to connect to the connector plug of the on-board computer 232.

An operator 205 preferably has a mobile communication device such as a tablet computer 110 in order to pair with a wireless network generated by the CVD 135 of the truck 210. The tablet computer 110 preferably comprises a graphical user interface 335, a processor 310, a WiFi radio 307, a BLUETOOTH radio 306, and a cellular network interface 308.

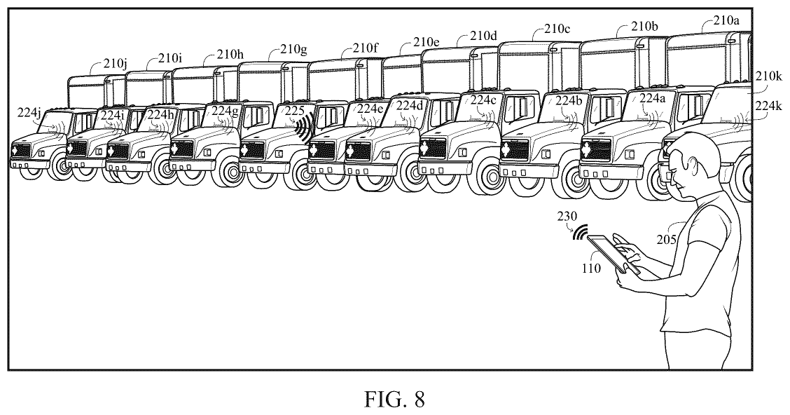

As shown in FIG. 8, each of a multitude of trucks 210a-210k broadcast a wireless signal 224a-k for a truck specific network, with one truck 210f broadcasting a wireless signal 225. However, all of the wireless signal 224a-224k and 225 do not publish their respective SSID so that a mobile device 110 must already be paired with the CVD 135 of the truck 210 in order to connect to the truck based wireless network 224a-224k or 225 of each of the CVDs 135 of each of the trucks 210a-210k. A operator 205 in possession of a tablet computer 110 pairs with the specific truck wireless network 225 of the CVD 135 of the truck 210f, and thus the operator locates the specific truck 210f he is assigned to in a parking lot full of identical looking trucks 210a-210k.

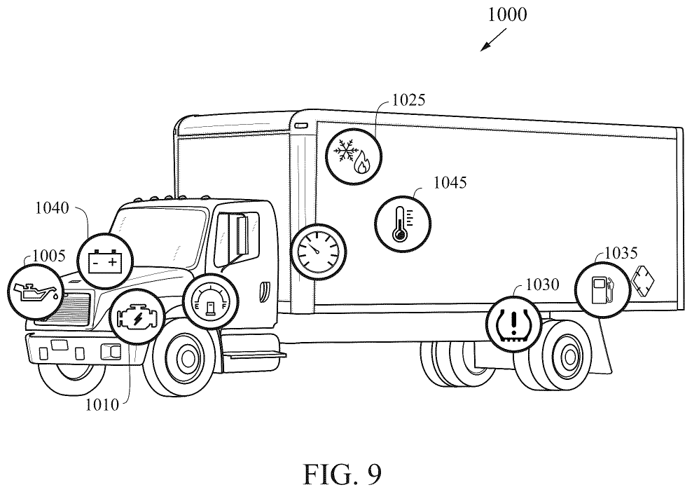

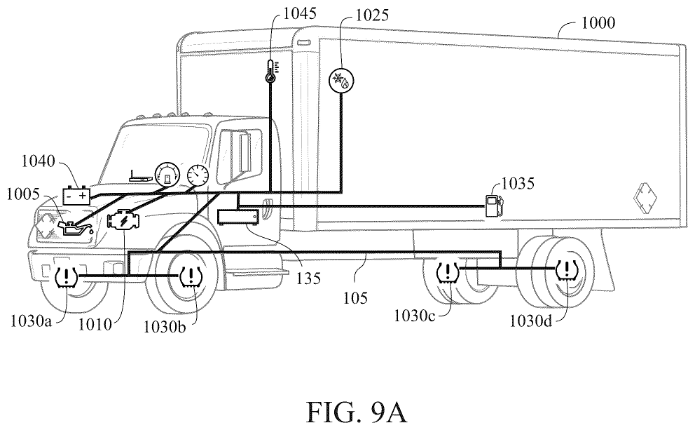

FIG. 9 is an illustration of multiple sensors on a truck 1000. The vehicle/truck 1000 preferably comprises an oil level sensor 1005, an engine sensor 1010, a power sensor 1040, a refrigeration/HVAC sensor 1025, a temperature sensor 1045, a tire pressure sensor 1030, and a fuel sensor 1035. Those skilled in the pertinent art will recognize that multiple other sensors may be utilized without departing from the scope and spirit of the present invention. FIG. 9A is an illustration of multiple sensors on a truck connected to a data bus 105 for the truck. Each of the sensors (oil level sensor 1005, engine sensor 1010, a power sensor 1040, a refrigeration/HVAC sensor 1025, a temperature sensor 10405, tire pressure sensors 1030a-d, and fuel sensor 1035) is preferably connected to the data bus 105 for transferring data to an on-board computer of the vehicle 1000, or directly to the CVD 135. Alternatively, some or all of the sensors use wireless communications to communication with the CVD 135.

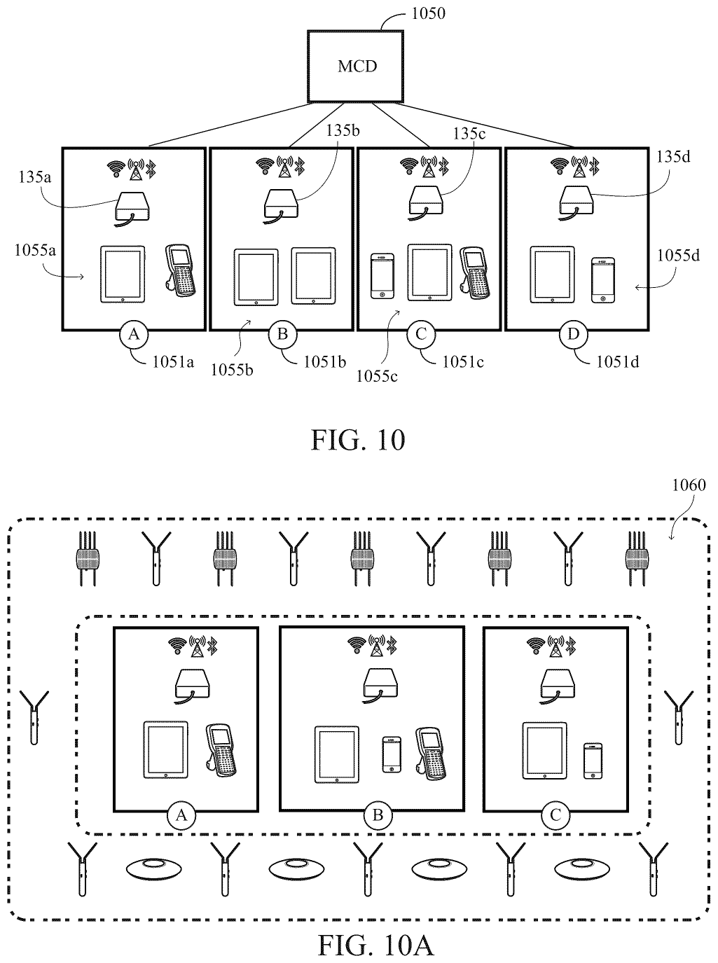

One embodiment is a system for managing radio frequency (RF) connections for a plurality of devices under the control of an assigning authority. The system comprises a management communication device 1050 and wireless communication devices 1055a-d, as shown in FIG. 10. The management communication device 1050 manages broadcast signal strength and reception sensitivity on each of the wireless communication devices 1055a-d. Each of the wireless communication devices 1055a-d is assigned to a set of wireless communication devices 1055a-d. The set 1051a-d includes devices that require pairing only between devices in the set 1051a-d. The management communication device 1050 prioritizes each of the wireless communication devices. FIG. 10A is an illustration of the embodiment showing the local RF network 1060.

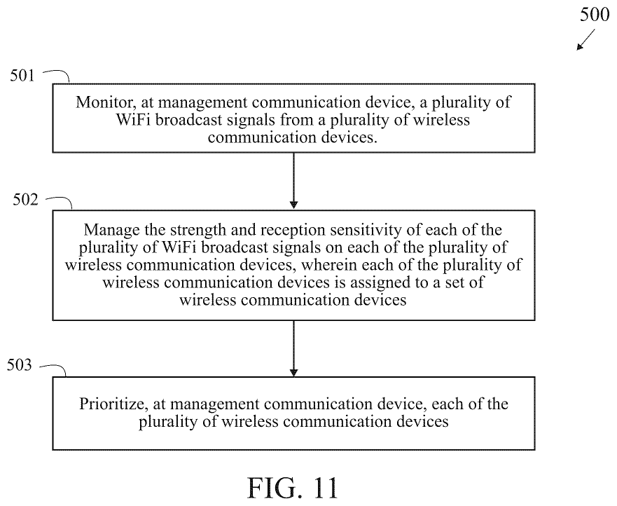

A method 500 for managing RF connections for a plurality of devices associated with a plurality of vehicles is shown in FIG. 11. Block 501starts with monitoring, at a management communication device, a plurality of WiFi broadcast signals from a plurality of wireless communication devices. At block 502, the strength and reception sensitivity of each of the plurality of WiFi broadcast signals on each of the plurality of wireless communication device is managed. Preferably, each of the plurality of wireless communication devices is assigned to a set of wireless communication devices. At block 503, each of the plurality of wireless communication devices is prioritized at the management communication device.

Another embodiment is a system for managing radio frequency (RF) connections for devices associated with vehicles. The system comprises a management communication device for a vehicle yard, and vehicle wireless communication devices. Each of the vehicle communication devices associated with a vehicle located within the vehicle yard. The management communication device manages broadcast signal strength and reception sensitivity on each of the vehicle wireless communication devices. Each of the vehicle wireless communication devices is assigned to a set of wireless communication devices of a plurality of sets. The set includes devices that require pairing only between devices in the set for a user configurable period of time, wherein the management communication device prioritizes each of the plurality of sets over one another.

A signal strength and a reception sensitivity are dynamically scaled up or down between each of the wireless communication devices in the set to optimize an ability of each of the wireless communication devices in the set to pair successfully, remain paired successfully, and/or re-pair successfully if pairing is interrupted.

The management communication device preferably controls a transmit power, a beacon interval rate, a radio-frequency channel, and/or changing a data rate based on wireless communication protocols.

The wireless communication devices preferably comprises a plurality of tablet computers and/or a plurality of CVD devices and the management communication device is a tablet computer, a remote server, a mobile communication device, a desktop computer, a laptop computer, or the like. Each of the wireless communication devices preferably controls a transmit power, a beacon interval rate, and or control changing a data rate based on wireless communication protocols. Control of each of the wireless communication devices is preferably based on a location of each of the wireless communication devices. Control of each of the wireless communication devices is preferably based on a geofence. Alternatively, control of each of the wireless communication devices is based on a state of a vehicle for each of the wireless communication devices. Alternatively, control of each of the wireless communication devices is based on a state of each of the wireless communication devices, wherein the state is on, off, in motion or standby. Alternatively, control of each of the wireless communication devices is based on a state of an operator or a work state for each of the wireless communication devices. Alternatively, control of each of the wireless communication devices is based on a hierarchal prioritization scheme employed by the authorized user or assigning authority for each of the wireless communication devices. Alternatively, control of each of the wireless communication devices is based on a priority for each of the wireless communication devices.

A channel randomization is preferably utilized to control at least one of congestion, security, prioritization, optimization of cost, optimization of bandwidth, or high power line interference.

The state of an operator or the work state comprises at least one of a determination if a tablet computer is active, a determination if a tablet computer is working with a CVD, or other certain information. The determination if a tablet computer is active preferably comprises at least one of is a screen on or off, is there motion, is the operator logged on, or is the operator on duty. The determination if a tablet computer is working with a CVD preferably comprises the CVD informing the tablet computer that the vehicle is approaching a location of WiFi congestion and to prepare for a configuration for congestion.

A trigger is preferably based on certain information that may include a geofence comprising presence in a predetermined location, dynamic self-awareness, the Cloud (based on location).

An assigning authority is preferably used to allow configurable controls, a prioritization scheme and/or a channel control. An assigning authority is preferably performed by a person or persons, who have the appropriate authority and mechanisms to assign specific tasks and assets to a specific vehicle and vehicle operator or custodian, and to assign workflow assignments to same.

A set preferably includes devices that require pairing only between devices in the set for a user configurable period of time.

The management communication device preferably prioritizes each of the wireless communication devices. In one embodiment, the management communication device is a CVD. In an alternative embodiment, the management communication device is a central control device for a vehicle yard. In an alternative embodiment, the management communication device is a server in the cloud. In an alternative embodiment, the management communication device is a router. In an alternative embodiment, the management communication device is a wireless point of access. In an alternative embodiment, the management communication device is a wireless communication device.

In one embodiment, each of the wireless communication devices is a tablet computer. In an alternative embodiment, the each of the wireless communication devices is a CVD. In an alternative embodiment, the each of the wireless communication devices is a mobile phone. In an alternative embodiment, each of the wireless communication devices is a router. In an alternative embodiment, each of the wireless communication devices is a wireless point of access. In an alternative embodiment, the wireless communication devices are a combination of tablet computer, a mobile phone, a CVD, router, and a wireless access point.

A connected vehicle device (CVD) preferably comprises a processor, a WiFi radio, a BLUETOOTH radio, a memory, and a connector for mating with the connector plug of the vehicle. A mobile device preferably comprises a graphical user interface, a mobile application, a processor, a WiFi radio, and a cellular network interface. A passive communication device preferably operates on a BLUETOOTH communication protocol. Each device is preferably for a vehicle and the vehicle is selected from a delivery truck, a semi-truck, a fleet truck, or the like.
Kennedy et al., U.S. patent application Ser. No. 16/912,265, filed on Jun. 25, 2020 for a Method And System For Generating Fueling Instructions For A Vehicle, is hereby incorporated by reference in its entirety.
Kennedy et al., U.S. Pat. No. 10,652,935 for Secure Wireless Networks For Vehicles, is hereby incorporated by reference in its entirety.
Kennedy et al., U.S. patent application Ser. No. 16/870,955, filed on May 9, 2020 for Secure Wireless Networks For Vehicle Assigning Authority, is hereby incorporated by reference in its entirety.
Kennedy et al., U.S. patent application Ser. No. 16/450,959, filed on Jun. 24, 2019 for Secure Wireless Networks For Vehicles, is hereby incorporated by reference in its entirety.
Son et al., U.S. Pat. No. 10,475,258 for a Method And System For Utilizing Vehicle Odometer Values And Dynamic Compliance, is hereby incorporated by reference in its entirety.
Son et al., U.S. Pat. No. 10,070,471 for a Secure Wireless Networks For Vehicles, is hereby incorporated by reference in its entirety.
Son et al., U.S. Pat. No. 10,652,935 for a Secure Wireless Networks For Vehicles, is hereby incorporated by reference in its entirety.
Kennedy et al., U.S. patent application Ser. No. 16/927,231, filed on Jul. 13, 2020 for a Remote Profile Manager For A Vehicle, is hereby incorporated by reference in its entirety.
Kennedy et al., U.S. patent application Ser. No. 17/022,027, filed on Sep. 15, 2020 for Micro-Navigation For A Vehicle, is hereby incorporated by reference in its entirety.
Kennedy et al., U.S. patent application Ser. No. 17/245,919, filed on Apr. 30, 2021 for Method And System For Vehicle Inspection, is hereby incorporated by reference in its entirety.
Kennedy et al., U.S. patent application Ser. No. 17/307,947, filed on May 4, 2021 for a System And Method To Generate Position And State-Based Electronic Signaling From A Vehicle, is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

We claim as our invention the following:

1. A system for managing radio frequency (RF) connections for a plurality of devices under the control of an assigning authority, the system comprising:
a management communication device;
a plurality of wireless communication devices;
wherein the management communication device manages broadcast signal strength and reception sensitivity on each of the plurality of wireless communication devices, wherein each of the plurality of wireless communication devices is assigned to a set of wireless communication devices, wherein the set includes devices that require pairing only between devices in the set, wherein the management communication device prioritizes or allocates each of the plurality of wireless communication devices.

2. The system according to claim 1 wherein a signal strength and a reception sensitivity are dynamically scaled up or down between each of the plurality of wireless communication devices in the set to optimize an ability of each of the plurality of wireless communication devices in the set to pair successfully, remain paired successfully, and/or re-pair successfully if pairing is interrupted.

3. The system according to claim 1 wherein the management communication device controls at least one of a transmit power, a beacon interval rate, a radio-frequency channel, or changing a data rate based on wireless communication protocols.

4. The system according to claim 1 wherein each of the plurality of wireless communication devices controls at least one of transmit power, a radio-frequency channel, a beacon interval rate or changing a data rate based on wireless communication protocols.

5. The system according to claim 1 wherein control of each of the plurality of wireless communication devices is based on at least one of a location of each of the plurality of wireless communication devices, a geofence, a state of an operator or a work state for each of the plurality of wireless communication devices, a state of a vehicle for each of the plurality of wireless communication devices, a hierarchal prioritization scheme employed by the authorized user or assigning authority for each of the plurality of wireless communication devices, a priority for each of the plurality of wireless communication devices, or a state of each of the plurality of wireless communication devices wherein the state is on, off, in motion or standby.

6. The system according to claim 1 wherein channel randomization is utilized to control at least one of congestion, security, prioritization, optimization of cost, optimization of bandwidth, or high power line interference.

7. The system according to claim 5 wherein the state of an operator or the work state comprises at least one of a determination if a tablet computer is active or a determination if a tablet computer is working with a CVD.

8. The system according to claim 7 wherein the determination if a tablet computer is active comprises at least one of is a screen on or off, is there motion, is the operator logged on, or is the operator on duty.

9. The system according to claim 7 wherein the determination if a tablet computer is working with a CVD comprises the CVD informing the tablet computer that a wireless communication device is approaching a location of WiFi congestion and to prepare for a configuration for congestion.

10. The system according to claim 1 wherein a trigger is based on certain information that may include a geofence comprising presence in a predetermined location, dynamic self-awareness, the Cloud (based on location).

11. The system according to claim 1 wherein an assigning authority is used to allow configurable controls, a prioritization scheme and/or a channel control.

12. The system according to claim 1 wherein the plurality of wireless communication devices comprises a plurality of tablet computers and/or a plurality of CVD devices and the management communication device is a tablet computer, a remote server, a mobile communication device, a desktop computer, or a laptop computer.

13. The system according to claim 1 wherein the set includes devices that require pairing only between devices in the set for a user configurable period of time.

14. The system according to claim 1 wherein each device is for a vehicle, each vehicle comprises an on-board computer with a memory having a VIN, a connector plug and a motorized engine, and the vehicle is selected from a delivery truck, a semi-truck, a fleet truck, or the like.

15. A method for managing radio frequency (RF) connections for a plurality of devices associated with a plurality of vehicles, the method comprising:
monitoring, at management communication device, a plurality of WiFi broadcast signals from a plurality of wireless communication devices;
managing the strength and reception sensitivity of each of the plurality of WiFi broadcast signals on each of the plurality of wireless communication devices, wherein each of the plurality of wireless communication devices is assigned to a set of wireless communication devices;
prioritizing, at management communication device, each of the plurality of wireless communication devices.

16. The method according to claim 15 further comprising at least one of preventing WiFi congestion, providing security, providing prioritization, optimizing cost, optimizing bandwidth, or preventing high power line interference.

17. The method according to claim 15 wherein a signal strength and a reception sensitivity are dynamically scaled up or down between each of the plurality of wireless communication devices in the set to optimize an ability of each of the plurality of wireless communication devices in the set to pair successfully, remain paired successfully, and/or re-pair successfully if pairing is interrupted.

18. The method according to claim 15 wherein the management communication device controls at least one of a transmit power, a beacon interval rate, a radio-frequency channel, or changing a data rate based on wireless communication protocols.

19. The method according to claim 15 wherein each of the plurality of wireless communication devices controls at least one of a transmit power, a radio-frequency channel, a beacon interval rate or changing a data rate based on wireless communication protocols.

20. The method according to claim 15 wherein control of each of the plurality of wireless communication devices is based on at least one of a location of each of the plurality of wireless communication devices, a geofence, a state of an operator or a work state for each of the plurality of wireless communication devices, a state of a vehicle for each of the plurality of wireless communication devices, a hierarchal prioritization scheme employed by the authorized user or assigning authority for each of the plurality of wireless communication devices, a priority for each of the plurality of wireless communication devices, or a state of each of the plurality of wireless communication devices wherein the state is on, off, in motion or standby.
